(19) United States
(12) Patent Application Publication
(10) Pub. No.: US 2024/0411921 A1
(43) Pub. Date: Dec. 12, 2024

(54) SYSTEM AND METHOD FOR PROTECTING FORM FIELD SENSITIVE DATA WITH DYNAMIC USER FEEDBACK

(71) Applicant: Capital One Services, LLC, McLean, VA (US)

(72) Inventors: Jagmeet B. SINGH, Burr Ridge, IL (US); Sudheendra Kumar KAANUGOVI, Aldie, VA (US); Jeremy GOODSITT, Champaign, IL (US); Dustin SUMMERS, Lovettsville, VA (US); Austin WALTERS, Savoy, IL (US); Rui ZHANG, New York, NY (US); Kenny BEAN, Herndon, VA (US)

(73) Assignee: Capital One Services, LLC, McLean, VA (US)

(21) Appl. No.: 18/208,616

(22) Filed: Jun. 12, 2023

(51) Int. Cl. G06F 21/62; G06F 40/174

(52) U.S. Cl. CPC G06F 21/6245; G06F 40/174

(57) ABSTRACT

A system and method for preventing erroneous data entry is disclosed. When presented with a form, such as in a website or an app, users are often requested to submit private information that should not be made public. However, form fields are often not protected, and users commonly erroneously enter private information into forms requesting non-private information. Therefore, an alternative entry display is provided to the user to allow the user to separately and securely submit form field entries. This display analyzes the information provided to the user to determine the type of data being requested by a selected form field. This information is used not only to prompt the user in the alternative entry display, but also to verify that the information provided by the user matches the type being requested for security purposes.

### TECHNICAL FIELD

Embodiments of the present disclosure are related to internet security, and specifically to detecting entry of private information in a non-secured form field.

### BACKGROUND

While browsing the Internet or using an app on a portable electronic device, users are often presented with forms by which they are able to submit information. These forms exist in a variety of different formats, specifically suited to the circumstances of the page being visited. Each form can include any number of form fields. While some form fields request non-private information, such as username and occupation, other form fields request private information, such as social security number, password, income, etc.

However, users often enter private information into non-secure form fields. Not only are these form fields often monitored, but the data entered can be viewed by non-trustworthy individuals.

### BRIEF DESCRIPTION OF THE DRAWINGS/FIGURES

The accompanying drawings are incorporated herein and form a part of the specification.

FIG. 1 illustrates a block diagram of an exemplary form monitoring environment according to various embodiments.

FIG. 2 illustrates a block diagram of an exemplary form monitoring system according to various embodiments.

FIG. 3A illustrates an exemplary user interface according to various embodiments.

FIG. 3B illustrates an exemplary user interface according to various embodiments.

FIG. 4 illustrates a block diagram of an exemplary form monitoring system according to various embodiments.

FIG. 5 illustrates a flowchart diagram of an exemplary method for monitoring electronic forms according to various embodiments.

FIG. 6 illustrates a flowchart diagram of an exemplary method for verifying data determinations according to various embodiments.

FIG. 7 illustrates an exemplary computer system for implementing some aspects of the disclosure or portion(s) thereof.

In the drawings, reference numbers generally indicate identical or similar elements. Additionally, generally, the left-most digit(s) of a reference number identifies the drawing in which the reference number first appears.

### DETAILED DESCRIPTION

Provided herein are a method, a system, computer program product embodiments, and/or combinations and sub-combinations thereof for preventing government-identification based fraud and/or fraudulent transactions.

While browsing the Internet or using an app on a portable electronic device, users are often presented with forms that include multiple fields that require data or information to be entered by the user. These forms exist in a variety of different formats, specifically suited to the circumstances of the page being visited. These forms may be associated with different companies, services, products, etc. For example, a user may request a loan from a bank. Each form can include any number of form fields. In the example of the bank, the form fields may request non-private information, such as username, and occupation, other form fields request private information, such as social security number, password, income, address, etc.

However, these forms are often not secure. In these instances, users often enter private information into non-secure form fields. Not only are these form fields often monitored by the company or service soliciting this information, but the data entered can be viewed by non-trustworthy individuals. As a result, there is a need for a system that identifies the presence of forms in a webpage or other electronic medium, notifying the user, and/or providing a secure means for submitting and verifying the entry of private information into the form.

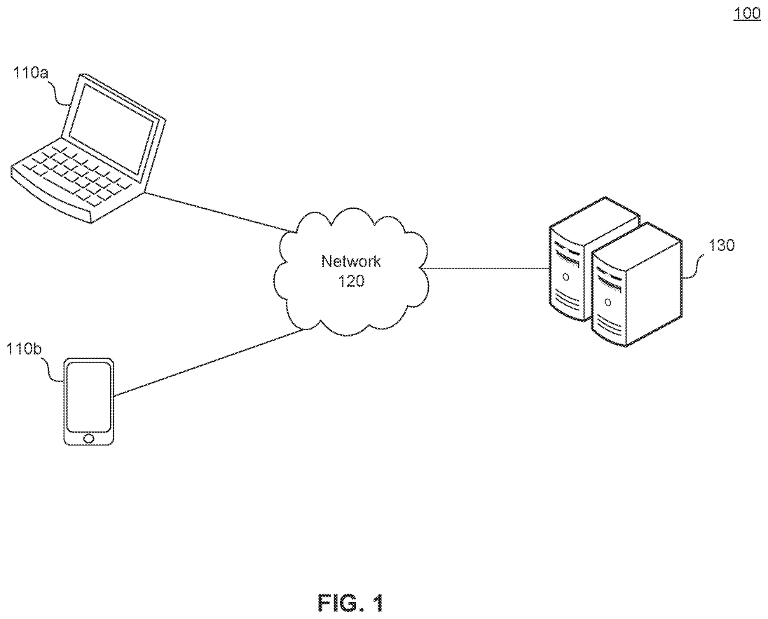

FIG. 1 illustrates a block diagram of exemplary form monitoring environment 100 according to various embodiments. As shown in FIG. 1, the environment 100 includes a user device 110a or 110b (collectively referred to as 110), a network 120, and a host server 130. In some embodiments, the one or more user devices can include mobile telephony devices, such as mobile phones, mobile computing devices, mobile internet devices, such as tablet computers and/or laptop computers, video game consoles, portable media players, peripheral devices, such as wireless speakers, mice, keyboards, monitors, printers, and/or scanners, internet capable appliances, smart televisions, signal extenders, mini boxes, and/or other suitable communication devices that are capable of wireless communication that will be recognized by those skilled in the relevant art(s) without departing from the spirit and scope of the present disclosure.

In embodiments, a user uses one of user device 110a in the form of a laptop computer or user device 110b in the form of cellular phone and accesses the host server 130 over the network 120. The network 120 can be implemented as a wireless communication network, a wireline communication network, and/or any combination thereof that will be apparent to those skilled in the relevant art(s) without departing from the spirit and scope of the present disclosure. In embodiments, the network 120 is any network capable of effecting communication between the user devices 110a/b and the host server 130, and may be a LAN, WAN, PAN, VPN, or other network and may include the Internet. In embodiments, the host server 120 may include any number of servers, computers, and/or databases for carrying out the functionality described herein.

As discussed above, the user may access the host server 130 for a variety of different reasons, such as to browse a host website, access account information, submit feedback, request a particular service, etc. In embodiments, host server 130 can include centralized data storage of the (encrypted) form data from devices, APIs for device communication, and/or one or more data policy components that determine what form fields are considered private. In further embodiments, the host server 130 also contains any machine-learning model training/support modules used for updating/retraining the machine-learning model. However, certain actions and/or pages of the host website may include one or more forms having one or more form fields through which the user submits or provides information to the host server.

In embodiments, the form monitoring system exists on the user device 110. In embodiments, the form monitoring system is a plugin or add-on to a browser of the device operating system. In other embodiments, the form monitoring system is a plug-in installed on an intermediate server that provides Internet or other access to the user, such as a work server. Alternatively, the form monitoring system is an application that is downloaded by the user and maintained on user device 110. As the user browses the Internet or navigates an app, the form monitoring system detects the presence of an electronic form. According to some embodiments, this detection can be based on an analysis of the webcode, image analysis of the page being viewed, or detection of input device commands, such as keypresses. Alternatively, the application or plug-in can query the user to determine whether a form is being completed.

As discussed above, the form includes any number of form fields. Typically, each form field is designated for a particular piece of information, such as name, address, phone number, email address, etc. Once the form monitoring system detects the presence of the form, the form monitoring system next detects whether the user has selected any of the fields of the form. In embodiments, the form monitoring system detects the field and determines a type of data being requested by the field. Once again, in embodiments, this can be performed in a variety of different ways, such as by analyzing the webcode of a website, image analysis, database look-up, etc.

At this point, depending on the type of information being requested, the form monitoring system can take one of multiple different actions. For example, in an embodiment, if the form monitoring system determines that the form field selected by the user is requesting non-private information, the form monitoring system may merely monitor the user's inputs to make sure that the user is not accidentally providing the form field with private information and/or to make sure that the information entered by the user matches the type of data being requested by the form field.

On the other hand, if the form field requests private information, then the form monitoring system presents an alternative entry display to the user. This alternative entry display can be in a variety of different formats. In an embodiment, the alternative entry display is an overlay or a pop-up window. In embodiments, the alternative entry display includes a form field and may include a message to the user warning them that private information has been requested and to securely provide the private information in the form field provided. In an embodiment, the presentation of the alternative entry display occurs regardless of the type of data being requested.

Regardless of whether the form monitoring system provides the alternative entry display to the user, the form monitoring monitors the data being entered by the user. In embodiments, the user's inputs are monitored based on keystroke monitoring, metadata associated with downloaded data, or other input monitoring techniques. Based on the monitoring, the form monitoring system determines a type of the data being submitted by the user. In an embodiment, the form monitoring system uses a machine learning model and/or a rule-based system/algorithm to identify the type of the data based on the data entry. Based on the type of determination, the form monitoring system verifies that the type of the data being submitted matches the type being requested.

Finally, if the form monitoring system detects that the data provided by the user does not match the data being requested, or some other error with the data, then the form monitoring system notifies the user as to the problem prior to inserting the data into the form. Alternatively, if the data matches the data being requested, then the data received in the alternative entry display is inserted into the form for submission. In this manner, secure form submission is provided. These, as well as other aspects of the disclosure will be discussed in further detail below with respect to the figures.

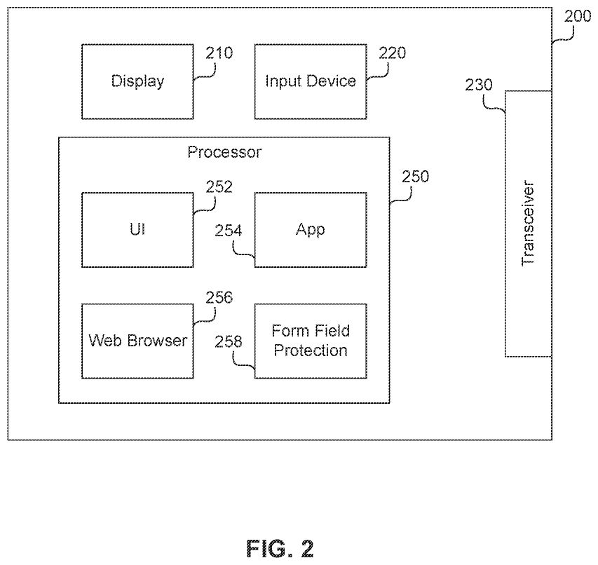

FIG. 2 illustrates a block diagram of an exemplary form monitoring system 200 according to various embodiments. As shown in FIG. 2, the form monitoring system 200 includes a display 210 for displaying information to the user, an input device 220 for receiving inputs from the user, a transceiver 230 for communicating with one or more external devices, and a processor 250 for carrying out the functions of the form monitoring process as described herein.

In an embodiment, the display is any suitable display device including but not limited to a liquid crystal display (LCD), light-emitting diode (LED) array, organic LED (OLED) array, plasma screen, etc. The display 210 receives display information from the processor 250 and generates images for viewing by the user. In an embodiment, the display 210 is a separate device from the system 200.

In an embodiment, input device 200 is any device suitable for providing input commands from a user to the system 200, including but not limited to a mouse, a keyboard, a joystick, a microphone, etc. In an embodiment, the input device is separate from the system 200.

In an embodiment, the transceiver 230 is a wired transceiver capable of transmitting electrical signals to an external device over one or more connected wires, such as CAT-6, coaxial, fiber optic, twisted pair, etc. In another embodiment, the transceiver 230 is a wireless transceiver configured to transmit signals over an air interface.

The processor 250 includes programming that, when executed by the processor, causes the processor to execute the functions of the form monitoring system 200. In an embodiment, the processor 250 includes a user interface function 252 configured to generate the display data and interface data for allowing the user to interact with the form monitoring system. The processor 250 also includes an app 254. In an embodiment, the app is any application running on the form monitoring system 200 or an associated user device 110 that may be monitored by the form monitoring system 200. Such an app may include a mobile banking app, a stock trading app, a communication app, a food ordering app, etc.

In an embodiment, the processor 250 also includes a web browser function that provides web connectivity to the user. The web browser 256 interfaces with web pages via the Internet, and generates the web pages for viewing by the user.

In an embodiment, the processor 250 also includes a form field protection function 258 that carries out the functions of the form field detection system described herein. The functionality of the form field protection function 258 will be described in further detail with respect to the following figures.

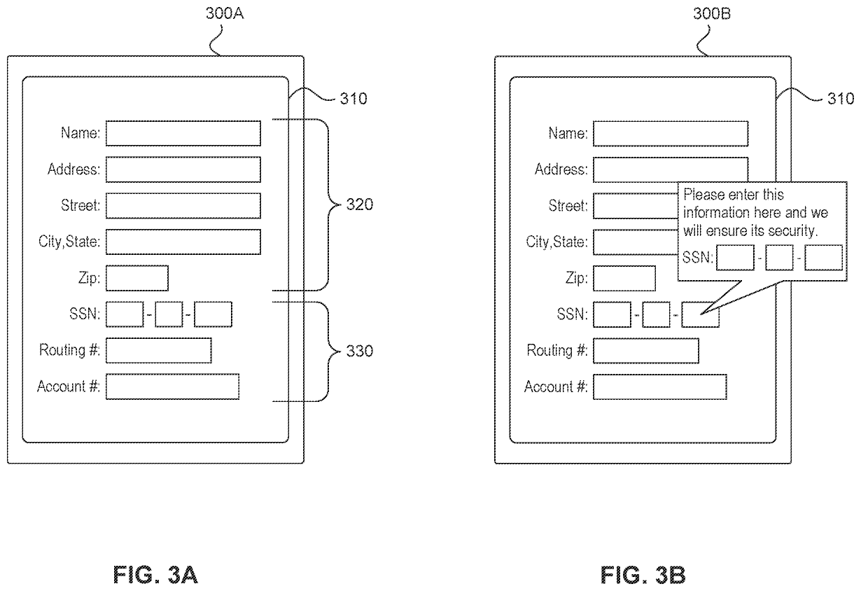

FIG. 3A illustrates an exemplary user interface 300A according to various embodiments. As shown in FIG. 3A, an exemplary user interface of an app or a website includes a form 310 depicted thereon. The form includes a plurality of form fields in which the user is able to enter data. In an embodiment, the form fields include non-private form fields 320 and private form fields 330. A POSA would understand that whether a field is designated private or non-private can change. For example, the address may be private or non-private depending on the individual. The non-private form fields 320 request information that is non-sensitive. On the other hand, the private form fields 330 request information that is sensitive, personal, and or should be protected from untrustworthy individuals. These fields include entries such as social security number, a bank routing number, an account number, etc.

In accordance with the present disclosure, when a user is presented with an interface as shown in FIG. 3A, the form monitoring system 200 detects the presence of the form. In an embodiment, upon the user selecting one of the form fields, the form monitoring system 200 presents the user with an alternative entry display 350, as shown for example in FIG. 3B.

FIG. 3B illustrates an exemplary user interface 300B according to various embodiments. As shown in FIG. 3B, the alternative entry display 350 is overlaid over the field of entry. As discussed above, in some embodiments, the alternative entry display 350 is provided for each form field selected by the user. However, in other embodiments, the alternative entry display 350 is provided only for form fields requesting private information. As shown, the alternative entry display 350 provides a mechanism for entry of the requested data separate from the form. In embodiments, the alternative entry display 350 includes one or more notifications to the user, such as instructions, warnings, or general notifications, etc.

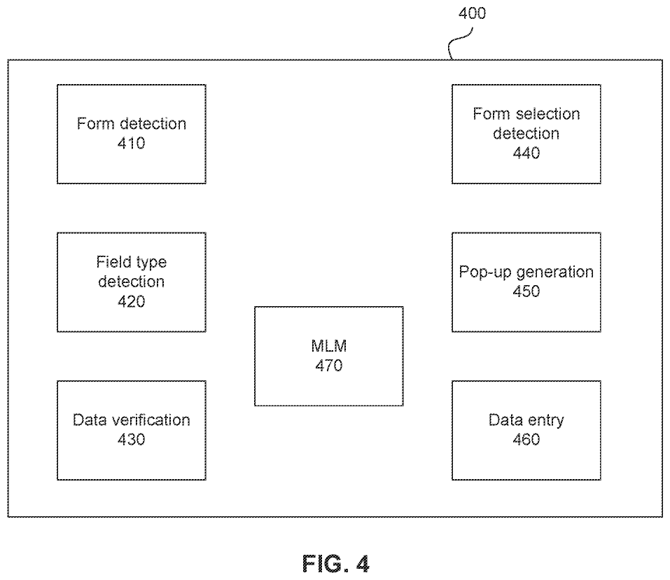

FIG. 4 illustrates a block diagram of an exemplary form field protection system 400 according to various embodiments. As shown in FIG. 4, the form field protection system 400 includes a form detection function 410, a form type detection function 420, a data verification function 430, a form selection detection function 440, a pop-up generation function 450, a data entry function 460, and a machine learning/rule-based model 470, and may represent an exemplary embodiment of form field protection function 258.

During operation, the form field protection system 400 monitors the activity of the user and the information being provided to the user through the user device 110. While doing so, the form detection function 410 detects the presence of a form being provided to the user. In embodiments, the form detection function 410 analyzes html or webcode associated with a current website being visited by the user to detect the form. Such a form may be labeled with a <form> or other similar tag in the code that can be identified by the form detection function 410. In another embodiment, the form detection function 410 performs image analysis to detect a form. Such image analysis occurs by the form detection function 410 comparing displayed information to known characteristics of forms, such as a word followed by white space either next to it or below. Through either or both of these analyses, the form detection function 410 identifies the presence of a form being provided to the user.

Form selection detection function 440 detects the user selecting a form field for data entry. In an embodiment, the form selection detection function 440 detects this based on user actions and inputs. For example, the form selection detection function 440 may monitor cursor position and user inputs, such as mouse clicks to detect the user selecting a form field. In another embodiment, the form selection detection function 440 performs image analysis to detect a form. Such image analysis occurs by the form selection detection function 440 comparing displayed information to known characteristics of forms, such as a cursor located within or blinking with a known form as detected by the form detection function 410. Through either or both of these analyses, the form selection detection function 440 identifies the user having selected a form field for data entry.

Field type detection function 420 identifies a type of data being requested by a particular form field. Specifically, once a form field selection has been identified by form selection detection 440, the field type detection function 420 determines the type of information being requested by the selected form field. In an embodiment, this is performed by analyzing the html or other webcode. Field labels will be included within the html code, and can be easily identified by reviewing the code, provided that the selected field is known. In another embodiment, image analysis is performed to extract the field name corresponding to the selected, which may include optical character recognition, or other techniques. Based on this analysis, the data type being requested is identified, which may include types such as name, address, social security number, etc.

In an embodiment, the field type detection function 620 also determines, based on the identified data type, whether the data type being requested is private information or non-private information. In an embodiment, a database, table or other storage device maintains a list of known private information data types. Thus, the determination of whether the requested data type is private is performed by the field type detection function 620 comparing the identified data type to the list of known private data types.

Pop-up generation function 450 generates the alternative entry display through which the user can enter the information for the selected form field. In an embodiment, the pop-up generation function 450 only generates the alternative entry display when the detected field type corresponds to private information. The pop-up generation function 450 generates an overlay, a pop-up window, or some other display mechanism for presenting to the user. Based on the data gathered by the form detection function 410 and the field type detection 420, the pop-up generation function 450 is made aware of the data type and the style of the form field presented to the user. Using this information, the pop-up generation function 450 generates the display to inform the user of the data type being requested, and provides the user with an alternative form field for entry of the requested data. For example, if the selected form field was identified as requesting a social security number, then the alternative entry display is generated to inform the user that a social security number is being requested, and provides the user with a new field for entry of the social security number.

The data verification function 430 reviews the data provided by the user, and verifies that the data provided matches the type requested. Specifically, the data verification function 430 receives the field type from the field type detection function 420. The data verification function 430 then obtains the data entered by the user. In an embodiment, when the data is entered into the alternative entry display, the data verification function 430 obtains the data from the pop-up generation 450. In another embodiment, no pop-up is provided to the user and the user enters the data directly into the form field of the page or app requesting the data. In this embodiment, the data verification 430 obtains the data provided by the user such as, for example, through input monitoring according to an embodiment. For example, after the form selection detection function 440 detects the user selection of a form field, then the data verification function 430 monitors keystrokes or other inputs to detect the data being entered by the user.

Upon obtaining the data entered by the user, the data verification function 430 validates the data against the requested data type. In other words, the data verification function 430 verifies that the type of the data provided by the user matches the data type being requested by the particular form field. In an embodiment, this is performed by providing the obtained data and the identified data type to the machine learning model 470. Machine learning model 470 is trained with a variety of different data entries and their corresponding types so as to be able to recognize data types associated with different data entries. In an embodiment, the model may be a character-level CNN/LSTM model (such as described in Truong, Anh, et al. “Sensitive data detection with high-throughput neural network models for financial institutions.” arXiv preprint arXiv: 2012.09597 (2020)) or Transformer model (such as described, for example, Xue, Linting, et al. “ByT5: Towards a Token-Free Future with Pre-trained Byte-to-Byte Models.” Transactions of the Association for Computational Linguistics 10 (2022): 291-306) In another embodiment, machine learning model 470 may also include or be replaced by a rules-based model that carries out a rules-based algorithm in order to identify the particular data type. Such rules may include one or more syntax comparators, character comparators, length checks, and others.

From the machine learning model 470, the data verification function 430 identifies the type of the data provided by the user and determines whether it matches the type of the data requested by the form field. If there is no match, then pop-up generation function 450 issues a warning and/or notification message to the user indicating that the data provided does not match the type requested by the form, and asks the user to either submit new data or confirm that the already-submitted data is accurate.

If, on the other hand, the data provided by the user matches the requested data type, then data entry function 460 enters the data in the appropriate form field. In an embodiment, the data entry function copies the data submitted by the user, automatically causes a selection of the form field in the webpage or app, and then issues a paste command to place the copied data into the form field. In another embodiment, the data entry function 460 stores or accesses the already-stored data provided by the user, and reenters the data in the appropriate form field. In another embodiment, the data entry function 460 causes the pop-up generation function 450 to provide a notification to the user indicating that the data provided is accurate, and requesting the user to copy and paste the data into the relevant form field. In another embodiment, the data entry function 460 modifies the html address for public forms to include the user's reply data. This embodiment, however, relies on the form data being public within the http address bar and known to the system.

In the manner described above, the form field protection 258 prevents a user from submitting erroneous or private information to a form, and specifically to an unprotected or unverified form.

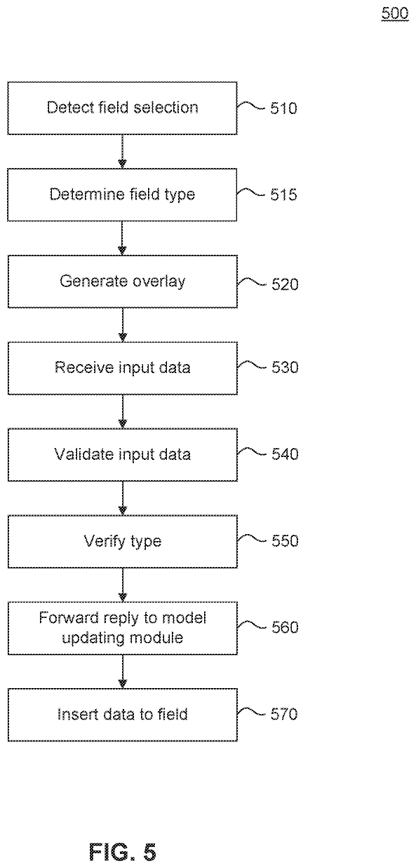

FIG. 5 illustrates a flowchart diagram of an exemplary method 500 for monitoring electronic forms according to various embodiments. Although the process described with reference to FIG. 5 is presented in a given order, alternative implementations may perform the steps in a different order, and some steps may be deleted, moved, added, subdivided, combined, or modified to provide alternative or sub-combinations. Each of these steps may be implemented in a variety of different ways. Also, while processes or methods are at times shown as being performed in series, these processes or blocks may instead be performed or implemented in parallel, or may be performed at different times.

As shown in FIG. 5, the method begins by detecting the user selecting a form field in step 510. Upon detecting the selection, a determination is made in step 515 as to the type of data being requested by the selected field. As discussed above, the field type can be determined by analyzing the html or other webcode or by performing image analysis to extract the field name corresponding to the selected field.

In step 520, based on the detected field type, an overlay is generated to provide the user with an alternative entry display for submitting the reply data outside of the form. In embodiments, the alternative entry display includes an indication of the data type being requested by the selected form field.

The user then enters the data into the alternative entry display, which is received by the alternative entry display in step 530. In step 540, the data provided by the user is validated against the detected field type. As discussed above, in embodiments, this may be performed by providing the obtained data and the identified data type to a machine learning model, which is trained with a variety of different data entries and their corresponding types so as to be able to recognize data types associated with different data entries. As a result of this step, the method verifies that the provided data matches a data type being requested.

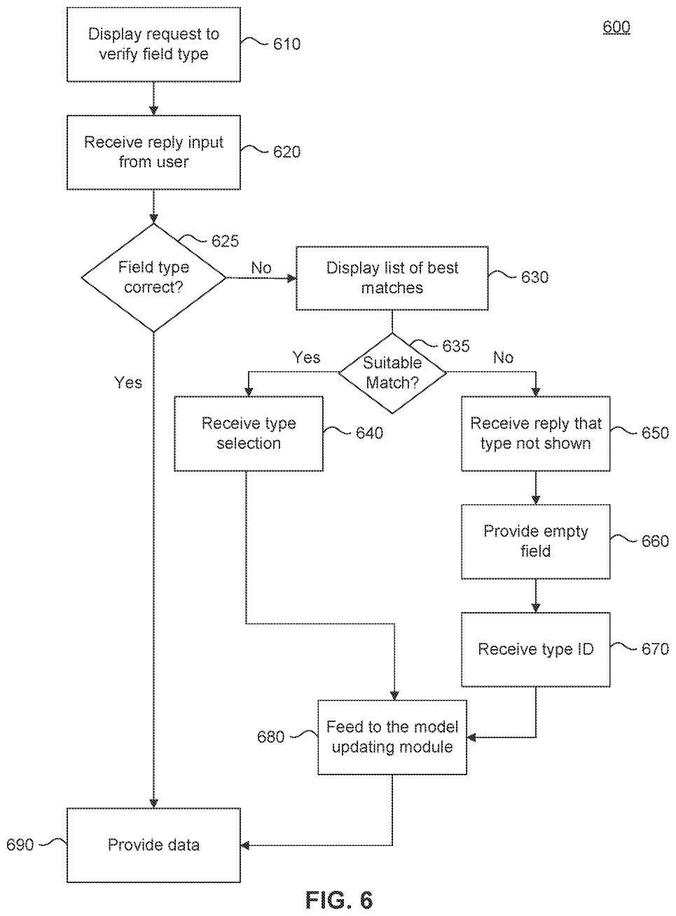

In embodiments, in step 550, the identified type of the data and/or the field is verified. For example, in some instances, there may be a desire to confirm the model's decision-making and/or allow for it to be retrained and/or incrementally improved (e.g., through incremental learning) for future decision-making. Thus, in this embodiment, the method prompts the user to verify one or both of the type determinations. For example, in an embodiment, the user can be notified of the determined field type and requested to verify that the identified field type is accurate. In another embodiment, the user can be notified of the validation decision in step 540, and asked to verify its accuracy. In other words, the user can be notified that the validation step 540 either succeeded or failed, and be requested to verify the accuracy of the decision. In an embodiment, if the user replies that any decision was incorrect, the user can be prompted to provide the proper determination (if that determination would not otherwise be clear from the context). This is described in further detail below with respect to FIG. 6.

In step 560, the method forwards the reply from the user in step 550 to facilitate model re-training and/or incremental learning. In particular, the proper determination and the data that should have led to it are provided to model re-training/incremental learning modules, which are not the subject of this disclosure. The machine learning model 470 is updated (by an external/server side module) using the data for improved future analyses. Step 560 is optional depending on whether facilities exist for such updates.

Once the proper data has been verified, the data is inserted into the relevant field in step 570. As discussed above, in an embodiment, the data is copied and then pasted to place the copied data into the form field. In another embodiment, the data is reentered in the appropriate form field. In another embodiment, the user is notified that the data provided is accurate, and requested to copy and paste the data into the relevant form field, etc.

FIG. 6 illustrates a flowchart diagram of an exemplary method 600 for verifying data determinations according to various embodiments. Although the process described with reference to FIG. 6 is presented in a given order, alternative implementations may perform the steps in a different order, and some steps may be deleted, moved, added, subdivided, combined, or modified to provide alternative or sub-combinations. Each of these steps may be implemented in a variety of different ways. Also, while processes or methods are at times shown as being performed in series, these processes or blocks may instead be performed or implemented in parallel, or may be performed at different times.

As shown in FIG. 6, the method begins by displaying a request to verify the type of the field in step 610. In an embodiment, this request is displayed in the overlay (e.g., the alternative entry display) provided to the user. In response, a reply is received from the user in step 620.

Based on the reply, a determination is made in step 625 as to whether the field type was correctly identified. For example, if the identified field type was verified by the user (625—Yes), then the method proceeds to step 690, where the data is input into the alternative entry display by the user is provided to the appropriate form field for submission. If, on the other hand, the identified field type is rejected by the user (625—No), then further steps are taken in order to determine the accurate field type.

In an embodiment, a list of best matches is displayed to the user in step 630. During the pattern matching process there will usually be multiple “candidates” that all match to varying degrees. Although the highest matching candidate will typically be selected as the identified type, when this selection is rejected by the user in step 625, the next closest matches can be displayed to the user in step 630. Based on this list, the user is able to determine whether there is a suitable match in step 635. If there is (635—Yes), the user can make a selection, from the list, of the proper type in step 640. This selection, along with the data originally obtained when determining the type, is then provided to the model in step 680 for retraining and/or incremental learning. In an example, a form field is identified as a social security number field, which the user rejects. In response, the system presents a list of closest matches, which based on the inclusion of multiple sub-fields or the inclusion of a “-” includes identifications such as social security number, telephone number, zip code, age bracket, etc. The user may then select one of these closest matches as being the correct identification of the form field, or may indicate that none of the provided options are correct. In response to the latter, the system provides the user with a text box or other data entry mechanism to allow the user to specify the correct form field tag.

Alternatively, in the event that there is no suitable match in the list provided to the user (635—No), the user can reply that the accurate type is not shown in step 650. In response, an empty field is displayed to the user in step 660 and the user is requested to type in the type of data being requested. In various embodiments, other mechanisms may be available for allowing the user to submit a custom reply. Based on the user's entry, the accurate field type is received in step 670. Then the accurate field type identified by the user and the data originally obtained when determining the type is provided to the model in step 680 for retraining and/or incremental learning.

Thereafter, in step 690, the data is provided to the appropriate form field for submission.

Although FIG. 6 has been described above in terms of verifying the accuracy of the field determination, the same or similar method could be carried out for verifying the accuracy of the identified type of the data submitted by the user. These and other embodiments will be apparent to a person of skill in the art.

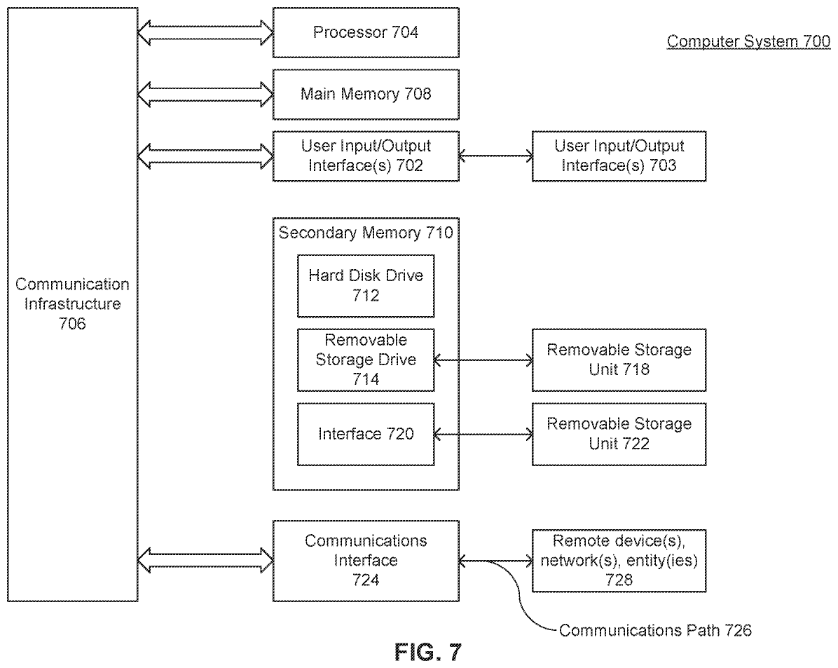

Various embodiments may be implemented, for example, using one or more well-known computer systems, such as computer system 700 shown in FIG. 7. One or more computer systems 700 may be used, for example, to implement any of the embodiments discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors, including processor 704, may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A data entry security system comprising:
a transceiver configured to communicate with an external device;
a display configured to display a user interface to a user, the user interface including a form field;
an input device configured to receive user inputs; and
one or more processors configured to:
detect that the user has selected the form field;
generate an alternative data entry field in the user interface configured to receive form field data from the user;
receive the form field data from the user via the alternative data entry field;
validate the form field data; and
automatically enter, in response to the validating, the form field data into the form field.

2. The data entry security system of claim 1, wherein the alternative data entry field is an overlay that includes a visual copy of the form field.

3. The data entry security system of claim 1, wherein the alternative data entry field is a pop-up window that includes the alternative data entry field.

4. The data entry security system of claim 1, wherein the one or more processors are further configured to detect a data type associated with the form field.

5. The data entry security system of claim 4, wherein the alternative data entry field is labeled with the data type.

6. The data entry security system of claim 4, wherein the validating includes:
identifying a data type associated with the form field data;
comparing the data type of the form field data to the data type of the form field; and
making a validation decision of validating or not validating the form field data based on the comparing of the data type.

7. The data entry security system of claim 6, wherein the one or more processors are further configured to, in response to not validating the form field data:
request confirmation from the user of the validation decision;
receive reply data from the user the denies the confirmation request;
in response to the reply data, request an actual data type from the user; and
provide the form field data and the actual data type to a model.

8. A method for data entry security, comprising:
displaying, to a user, a user interface having a form field;
detecting selection of the form field;
generating an alternative data entry field in the user interface configured to receive form field data from the user;
receiving the form field data from the user via the alternative data entry field;
validating the form field data; and
automatically entering, in response to the validating, the form field data into the form field.

9. The method of claim 8, wherein the alternative data entry field is an overlay that includes a visual copy of the form field.

10. The method of claim 8, wherein the alternative data entry field is a pop-up window that includes the alternative data entry field.

11. The method of claim 8, further comprising detecting a data type associated with the form field.

12. The method of claim 11, further comprising labeling the alternative data entry field with the data type associated with the form field.

13. The method of claim 11, wherein the validating includes:
detecting a data type associated with the form field data;
comparing the data type of the form field data to the data type of the form field; and
making a validation decision of validating or not validating the form field data based on the comparing of the data type.

14. The method of claim 11, further comprising:
requesting confirmation from the user of the validation decision;
receiving reply data from the user denying the confirmation request;
in response to the receiving of the reply data, request an actual data type from the user; and
provide the form field data and the actual data type to a model.

15. A method for securely entering data in a form, comprising:
detecting selection of a form field by a user in a user interface;
in response to the detecting, providing to the user an alternative form field;
receiving form field data via the alternative form field from the user;
validating that the form field data corresponds to the data requested by the form field; and
automatically entering the form field data into the form field in response to the validating.

16. The method of claim 15, further comprising:
generating a secondary user interface that includes the alternative form field,
wherein the providing includes displaying the secondary user interface to the user.

17. The method of claim 16, wherein the secondary user interface is displayed to the user as one of a pop-up window or an overlay.

18. The method of claim 16, wherein the validating includes:
detecting a first data type associated with the form field;
detecting a second data type associated with the form field data; and
comparing the first data type and the second data type.

19. The method of claim 18, wherein the validating further includes:
determining that the first data type and the second data type do not match;
request an actual data type from the user, and
perform an updated comparison between the second data type and the actual data type.

20. The method of claim 19, further comprising:
providing the form field data, the detected first data type and the actual data type to an external model; and
updating the model based on the form field data, the detected first data type, and the actual data type.
